(19) United States
(12) Patent Application Publication
(10) Pub. No.: US 2015/0245081 A1
(43) Pub. Date: Aug. 27, 2015

(54) METHODS AND SYSTEMS FOR PRESENTING SUPPLEMENTAL CONTENT IN RESPONSE TO DETECTING A SECOND DEVICE

(71) Applicant: United Video Properties, Inc., Santa Clara, CA (US)

(72) Inventor: Sally T. Cook, San Jose, CA (US)

(73) Assignee: United Video Properties, Inc., Santa Clara, CA (US)

(21) Appl. No.: 14/191,734

(22) Filed: Feb. 27, 2014

(51) Int. Cl. H04N 21/24; H04N 21/414; H04N 21/41; H04N 21/262; H04N 21/488; H04N 21/422; H04N 21/45; H04N 21/436; H04N 21/4788

(52) U.S. Cl. CPC H04N 21/2407; H04N 21/43615; H04N 21/41407; H04N 21/4122; H04N 21/4126; H04N 21/4788; H04N 21/4882; H04N 21/42202; H04N 21/4524; H04N 21/26283; H04N 21/26258

(57) ABSTRACT

Methods and systems are disclosed herein for a media guidance application that alleviates the burden on a user of describing the events of a media asset to another user that begins watching the media asset after the media asset has begun. For example, a media guidance application may determine that a first device (e.g., a smartphone carried by a first user) has entered a location at which an already in progress media asset is being presented on a second device (e.g., a television viewed by a second user). In response, the media guidance application determines the events that have thus transpired in the media asset, and generates for display a summary of the events on the first device.

### BACKGROUND

Recent advances have allowed users to access media on mobile devices for which they previously could not. Despite these advances, many users prefer to access content at a single location (e.g., at home) and with others (e.g., family and friends). That said, scheduling and travel conflicts often disrupt the ability of all users to start watching media assets at a specific time. Moreover, describing, to a user that arrives late, the events in a media asset that have led to the current circumstances of the media asset is often distracting to other users.

### SUMMARY

Accordingly, methods and systems are disclosed herein for a media guidance application that alleviates the burden on a user of describing the events of a media asset to another user that begins watching the media asset after the media asset has begun. More specifically, a media guidance application described herein may determine that a first device (e.g., a smartphone carried by a first user) has entered a location at which an already-in-progress media asset is being presented on a second device (e.g., a television viewed by a second user). In response to determining that the media asset is already in progress on the second device, the media guidance application determines the events that have thus transpired in the media asset, and generates for display a summary of the events on the first device. Consequently, the first user does not need to distract the second user from viewing of the media asset on the second device by asking questions related to the progress of the media asset.

In some aspects, the media guidance application may determine a first device has entered a predetermined proximity to a second device while the second device was presenting a media asset, and in response to determining the first device has entered the predetermined proximity to the second device while the second device was presenting the media asset, the media guidance application may determine a current progress point of the media asset on the second device. For example, the media guidance application may associate a particular viewing area with a particular device. In response to detecting that a user (e.g., via a user device carried with the user) has entered a viewing area associated with another device (e.g., based on the first device connecting to a home network associated with the second device, based on data received from a global positioning system, etc.), the media guidance application may determine if other content is being presented on that device. If content is being presented on the other device, the media guidance application may determine the progress point of that content.

The media guidance application may then cross-reference the progress point with a database listing supplemental media assets that are appropriate for presentation on the first device, in which each of the supplemental media assets corresponds to different progress points of the media asset, to identify a supplemental media asset for presentation on the second device. The media guidance application may then instruct the first device to generate for presentation the identified supplemental media asset. For example, in response to determining that another device is already presenting a media asset, the media guidance application may identify a supplemental media asset, from a plurality of supplemental media assets, for presentation to the user on the first device based on the current progress point.

For example, in some embodiments, the identified supplemental media asset may include a summary of the media asset, in which the summary summarizes the content of the media asset from a beginning point of the media asset only up to the current progress point (e.g., allowing a user to understand the events of the media asset thus far). In some embodiments, the identified supplemental media asset may include a portion of the media asset beginning at a beginning point of the media asset and ending at the current progress point (e.g., allowing a user to re-watch a portion of the media asset). In some embodiments, the identified supplemental media asset indicates an amount of time remaining in the media asset (e.g., allowing a user to determine whether to catch up on the current viewing of the media asset or instead view the media asset at a later time).

In some embodiments, the media guidance application may further instruct the first device to generate for display a prompt indicating that the supplemental media asset is available, and the media guidance application may receive a user input in response to the prompt requesting the supplemental media asset. For example, prior to generating for presentation on the first device the identified supplemental media asset, the media guidance application may query the user (e.g., via the first user device) as to what supplemental media asset, if any, a user wishes to have presented.

In some embodiments, the first user device, or a media guidance application implemented thereon, may determine a length of time remaining in the media asset by retrieving scheduling information associated with the media asset, determining a current time (e.g., via a clock or counter function), and comparing the current time to the schedule information to determine the length of time remaining in the media asset. For example, in response to determining that a media asset was scheduled to end at nine o'clock and the current time is eight-thirty, the media guidance application may determine that the media asset will end in thirty minutes.

In some embodiments, supplemental media assets (e.g., as listed in the database) that are appropriate for presentation on the first device are in a format corresponding to the first device. For example, the media guidance application may determine a format, screen size, connection speed, etc. associated with the first device and identify only supplemental media assets that correspond.

In some embodiments, the media guidance application may determine whether the media asset is currently being recorded, and in response to determining that the media asset is currently being recorded, cancel the instruction to generate for presentation the supplemental media asset on the first device. For example, the media guidance application may determine whether or not a user is likely to wish to re-watch the media asset in its entirety, and based on this determination may identify the supplemental media assets, if any, for presentation on the first device. Furthermore, the determination of whether or not a user is likely to wish to re-watch the media asset in its entirety may be based on many factors, such as: the current progress point of the media asset on the second device, the length of time remaining in the media asset, whether or not the media asset is being recorded, user preferences, additional information stored in a user profile, a viewing history, etc.

It should be noted, the systems and/or methods described above may be combined with, applied to, or used in accordance with, other systems, methods and/or apparatuses discussed both above and below.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance display for navigating and selecting media assets in accordance with some embodiments of the disclosure;

FIG. 2 shows another illustrative example of a media guidance display for selecting supplemental content in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A is an example of a first device entering a predetermined proximity to a second device in accordance with some embodiments of the disclosure;

FIG. 5B is an example of a first device generating a prompt related to supplemental media assets in accordance with some embodiments of the disclosure;

FIG. 6 is a flowchart of illustrative steps for instructing the first device to generate for presentation the identified supplemental media asset in accordance with some embodiments of the disclosure; and

FIG. 7 is a flowchart of illustrative steps for determining whether or not to request a supplemental media asset in accordance with some embodiments of the disclosure.

### DETAILED DESCRIPTION OF THE DRAWINGS

Methods and systems are disclosed herein for a media guidance application that alleviates the burden on a user of describing the events of a media asset to another user who begins watching the media asset after the media asset has begun. For example, a media guidance application may determine that a first device (e.g., a smartphone carried by a first user) has entered a location at which a media asset is currently being presented on a second device. In response to determining that the media asset is already in progress on the second device, the media guidance application determines a supplemental media asset that corresponds to the current progress point of the media asset and presents the supplemental media asset on the first device.

As used herein, “a media guidance application,” “interactive media guidance application,” or “guidance application” refer to a form of media guidance through an interface that allows users to efficiently navigate, identify, view, playback, and/or obtain information about content that they may desire. In some embodiments, the media guidance application may be provided as an on-line application (i.e., provided on a website), or as a stand-alone application on a server, user device, etc. Various devices and platforms that may implement the media guidance application are described in more detail below. In some embodiments, the media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media card, register memory, processor caches, Random Access Memory (“RAM”), etc.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

In some embodiments, the media guidance application may determine a first device has entered a predetermined proximity to a second device while the second device was presenting a media asset. For example, the media guidance application may associate a particular viewing area with a particular device. As used herein, a “viewing area” refers to the maximum distance from a user device, in all directions, in which a user could feasibly consume a media asset present on the user device. For example, if the user device is a television, the viewing area may refer to the maximum distance from the television at which the average user can understand the content presented. In some embodiments, the viewing area may correspond to a perceivable range. Various systems and methods for detecting whether or not a user is within a range are discussed in, for example, Shimy, U.S. Patent Application Publication No. 2011/0069940, published May 24, 2011, which is hereby incorporated by reference herein in its entirety.

In some cases, the size of a viewing area is a function of the obstacles surrounding the user device. For example, if a personal computer resides in a small room with walls that prevent a user on an opposite side of the walls from understanding content presented on the personal computer the viewing area of personal computer corresponds to the area within the walls. Alternatively, if one of the walls were removed, such that a user, formerly opposite of the removed wall from the personal computer, can now understand the content presented on the personal computer, the viewing area associated with the personal computer has now expanded in the direction of the removed wall.

In some cases, the size of a viewing area is a function of the objects surrounding the user device. For example, if a television resides in a room with other devices, the audio output of which, prevent a user a particular distance away from the television from hearing content presented on the television, the viewing area of television corresponds to the maximum distance away from the television that the user can hear content presented on the television due to the audio output of the other devices. Alternatively, if one of the other devices were removed, such that a user that could not previously hear content presented on the television can now hear the content presented on the television, the viewing area associated with television has now expanded due to the removal of the other device.

In some embodiments, the viewing area associated with a user device may correspond to the predetermined proximity to the user device. Alternatively, the predetermined proximity may refer to another area, which may or may not be associated with geographical boundaries and/or distances. For example, the predetermined proximity may refer to a finite measurement of distance from a user device. However, in another example, the predetermined proximity may refer to an area at which user devices may connect with a network (e.g., a home network).

For example, to determine whether or not a first user device is within a predetermined proximity to a second user device, the media guidance application may base its determination on whether or not the first device can connect to a home network associated with the second device. In another example, to determine whether or not a first user device is within a predetermined proximity to a second user device, the media guidance application may base its determination on data received from a global positioning system (e.g., indicating that the first device is within a particular geographical boundary and/or distance). In yet another example, to determine whether or not a first user device is within a predetermined proximity to a second user device, the media guidance application may base its determination on whether or not a user input is received indicating that the first user device is within the predetermined proximity.

To determine that a media asset is currently being presented on the second user device, the media guidance application may receive status information from the second user device. For example, the status information may indicate that the second user device is in an active state (e.g., the second user device is powered-on), may indicate the content currently presented on the second user device, may indicate the provider of the content and/or any other media guidance data associated with the second user device.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions), ratings information (e.g., parental control ratings, critic's ratings, etc.), genre or category information, actor information, logo data for broadcasters' or providers' logos, etc., media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

In response to determining the first device has entered the predetermined proximity to the second device while the second device was presenting the media asset, the media guidance application may determine a current progress point of the media asset on the second device. As used herein, a “progress point” refers to a finite location in the play length of a media asset. The progress point may indicate the location along the play length of the media asset in various terms (e.g., a minute mark, frame, scene, chapter, etc.).

In some embodiments, the status information may include the current progress point of the media asset on the second device. Alternatively or additionally, the media guidance application may determine the current progress point of a media asset by comparing the current time to scheduling information associated with the media asset. For example, the media guidance application may retrieve scheduling information associated with the media asset, determine a current time (e.g., via a clock or counter function), and compare the current time to the scheduling information to determine the current progress point of the media asset based on the scheduling information. For example, in response to determining that a media asset was scheduled to begin at eight o'clock and the current time is eight-thirty, the media guidance application may determine that the media asset is thirty minutes into its play length.

The media guidance application may cross-reference the progress point with a database listing supplemental media assets that are appropriate for presentation on the first device, in which each of the supplemental media assets corresponds to different progress points of the media asset, to identify a supplemental media asset for presentation on the second device. As referred to herein, a “supplemental media asset” is any media content that is appropriate for display on a first device and is associated with a media asset currently presented on the second device. Furthermore, supplemental media assets may be associated with different progress points in a media asset presented on a second device. For example, a supplemental media asset may include content that corresponds to any location along the play length of the media asset (e.g., a particular minute mark, frame, scene, chapter, etc.).

For example, a supplemental media asset may include a summary of the media asset, in which the summary summarizes the content of the media asset from a beginning point of the media asset only up to the current progress point (e.g., allowing a user to understand the events of the media asset thus far). In another example, a supplemental media asset may include a portion of the media asset beginning at a beginning point of the media asset and ending at the current progress point (e.g., allowing a user to re-watch a portion of the media asset). In another example, a supplemental media asset may indicate an amount of time remaining in the media asset (e.g., allowing a user to determine whether to catch up on the current viewing of the media asset or instead view the media asset at a later time).

In some embodiments, supplemental media assets that are appropriate for presentation on a first device are in a particular format corresponding to the first device. For example, if the first device is only compatible with files featuring a subset of file extensions, the media guidance application may determine that only files with file extensions of the particular type are appropriate as supplemental media assets. In another example, if the first device is only associated with a particular content quality (e.g., standard-definition), the media guidance application may determine that only supplemental media assets with corresponding content quality is appropriate as supplemental media assets. In another example, if the first device is only compatible with files of a certain size, the media guidance application may determine that only files with that size are appropriate as supplemental media assets. In another example, if the first device is only capable of receiving data at a particular connection speed, the media guidance application may determine that only media content that can be sent at that connection speed are appropriate as supplemental media assets.

In some embodiments, the format of the media asset may also relate to the content of the media asset. For example, if the media asset on the second device is presented in a particular language, the media guidance application may determine that only media content in that language is appropriate as supplemental media assets. In another example, if the media asset on the second device is presented with particular parental control settings (e.g., editing out graphic content), the media guidance application may determine that only media content that corresponds to the parental control settings is appropriate as supplemental media assets.

In some embodiments, the media guidance application may select the supplemental media assets from a plurality of supplemental media assets based on the progress of the media asset on the second user device. For example, the media guidance application may input a current progress point into a database listing supplemental content associated with different progress points in the media asset. The media guidance application may then filter the supplemental media assets in the database based on whether or not the supplemental media asset corresponds to the current progress point. The database may then output to the media guidance application one or more supplemental media assets that correspond to the current progress point.

In some embodiments, the media guidance application may create custom supplemental media assets. For example, the media guidance application may use a content recognition module or algorithm to generate data describing the context, content, and/or any other data necessary for generating supplemental media assets associated with a current progress point in a media asset. For example, the content recognition module may use object recognition techniques such as edge detection, pattern recognition, including, but not limited to, self-learning systems (e.g., neural networks), optical character recognition, on-line character recognition (including but not limited to, dynamic character recognition, real-time character recognition, intelligent character recognition), and/or any other suitable technique or method to determine objects in the media asset.

For example, the media guidance application may receive data in the form of a video. The video may include a series of frames. For each frame of the video, the media guidance application may use a content recognition module or algorithm to determine the objects (e.g., people, places, things, etc.) in each of the frames or series of frames, which may be used to generate a summary of the media asset. For example, based on the detection of a multitude of explosions in the frames, the media guidance application may determine the media asset, up to this point, has included a fight scene.

In some embodiments, the content recognition module or algorithm may also include speech recognition techniques, including, but not limited to, Hidden Markov Models, dynamic time warping, and/or neural networks (as described above) to translate spoken words into text and/or processing audio data. The content recognition module may also combine multiple techniques to generate custom supplemental media assets.

In addition, the media guidance application may use multiple types of optical character recognition and/or fuzzy logic, for example, when processing keyword(s) retrieved from data (e.g., textual data, translated audio data, user inputs, etc.) describing the media asset (or when cross-referencing various types of data in databases). For example, if the particular data received is textual data, using fuzzy logic, the media guidance application (e.g., via a content recognition module or algorithm incorporated into, or accessible by, the media guidance application) may determine two fields and/or values to be identical even though the substance of the data or value (e.g., two different spellings) is not identical. In order to determine a characteristic of a media asset in some embodiments, the media guidance application may analyze data of a data structure or media asset frame for particular values or text using optical character recognition methods described above. For example, the media guidance application may process subtitles of the media asset to find particular characters or events that occurred in a media asset in order to summarize the media asset for a user.

In another example, the first user device, or a media guidance application implemented thereon, may determine a length of time remaining in the media asset by retrieving scheduling information associated with the media asset, determining a current time (e.g., via a clock or counter function), and comparing the current time to the schedule information to determine the length of time remaining in the media asset. For example, in response to determining that a media asset was scheduled to end at nine o'clock and the current time is eight-thirty, the media guidance application may determine that the media asset will end in thirty minutes. The media guidance application may then include this information as a supplemental media asset.

The media guidance application may instruct the first device to generate for presentation the identified supplemental media asset. For example, in response to determining that another device is already presenting a media asset, the media guidance application may identify a supplemental media asset, from a plurality of supplemental media assets, for presentation to the user on the first device based on the current progress point.

For example, in some embodiments, a first device may be the device for which a media asset is currently being presented on, and a second device may be the device on which a supplemental media asset is presented. In some embodiments, a first device may be the device for which the predetermined proximity is defined, and a second device may be a device that enters the predetermined proximity.

In some embodiments, the media guidance application may further instruct the first device to generate for display a prompt indicating that the supplemental media asset is available, and the media guidance application may receive a user input in response to the prompt requesting the supplemental media asset. For example, prior to generating for presentation on the first device the identified supplemental media asset, the media guidance application may query the user (e.g., via the first user device) as to what supplemental media asset, if any, a user wishes to have presented. For example, if a database listing supplemental media assets that are appropriate for presentation on the first device corresponding to different progress points outputs a plurality of supplemental media assets, the media guidance application may offer the various options to a user via a display on the first device.

In some embodiments, the media guidance application may determine whether or not to generate for display supplemental media assets based on additional factors. As referred to herein, an “additional factor” is any criteria, other than a user input, that the media guidance application user to automatically determine whether or not to instruct a user device to generate for display a supplemental media asset. For example, an additional factor may include whether the media asset is currently being recorded. If so, the media guidance application may cancel the instruction to generate for presentation the supplemental media asset on a user device. For example, the media guidance application may determine that because the user has recorded the media asset, the user is likely to wish to re-watch the media asset in its entirety. Accordingly, the media guidance application may determine not to generate for display supplemental media assets due to a risk of spoiling the outcome of the media asset.

In another example, an additional factor may include the current progress point of the media asset. For example, the media guidance application may determine that because the current progress point is near the beginning of the media asset, no supplemental media assets are necessary. Alternatively, the media guidance application may determine that because the current progress point is near the end of the media asset, the user is unlikely to wish to invest any time catching up to the progress of the media asset.

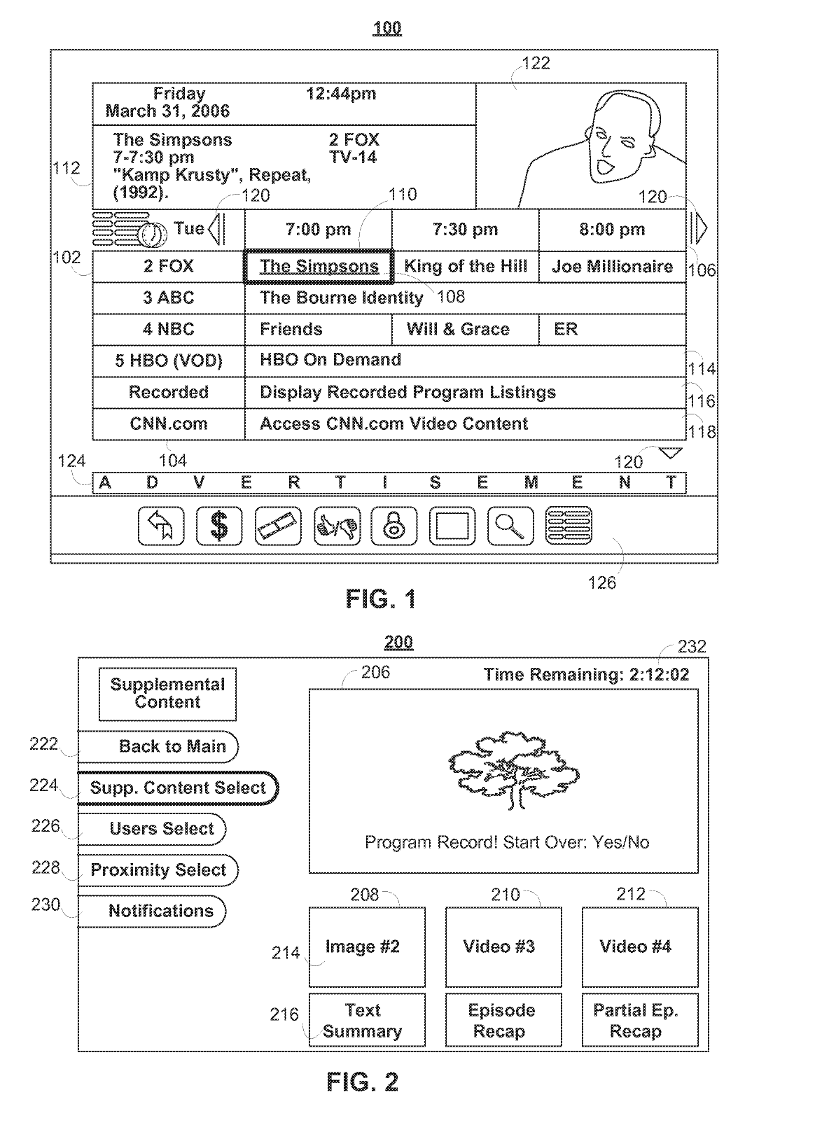

FIGS. 1-2 and FIG. 5B show illustrative display screens that may be used to access media assets, supplemental media assets, and/or media guidance data. The display screens shown in FIGS. 1-2 and 5B may be implemented on any suitable user equipment device or platform. While the displays of FIGS. 1-2 and 5B are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. For example, display 100 may indicate media assets available for presentation to a user. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media assets, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes supplemental media assets 206, 208, 210, and 212. For example, display 200 may represent a menu generated by the media guidance application on a user device through which a user may customize and/or select settings associated with sending and receiving supplemental media assets. Display 200 also includes supplemental media asset 232, which indicates the amount of time remaining in the media asset.

Supplemental media assets 206, 208, 210, and 212 may represent the various types of supplemental media assets that correspond to a current progress point of a user. For example, supplemental media asset 206 may feature a recording of the entire media asset up to the current progress point. In response to a user selection of supplemental media asset 206, the media guidance may begin playing back the media asset in its entirety. Supplemental media asset 208 may feature a textual summary of the media asset up to the current progress point. In response to a user selection of supplemental media asset 206, the media guidance may begin display text summarizing the media asset. Supplemental media asset 210 may feature a video recap of the entire media asset. In response to a user selection of supplemental media asset 210, the media guidance may begin playing back the video recap featuring content related to the entire media asset. Supplemental media asset 212 may feature a video recap of a portion of the media asset (e.g., from the beginning of the media asset up to the current progress point). In response to a user selection of supplemental media asset 212, the media guidance may begin playing back the partial video recap.

In addition to supplemental media assets 206, 208, 210, and 212, display 200 may provide information associated with the supplemental media assets. For example, media asset 208 may include more than one portion, including media portion 214 and text portion 216. Media portion 214 and/or text portion 216 may be selectable (e.g., via a user interaction at an object to which display 200 is fixed) to view content in full-screen or to view information related to the content displayed in media portion 214 (e.g., to view listings for the channel that the video is displayed on).

Supplemental media assets 206, 208, 210, and 212 in display 200 are of different sizes (i.e., supplemental media asset 206 is larger than supplemental media assets 208, 210, and 212), but if desired, all the media assets may be the same size. Supplemental media assets may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Display 200 also includes selectable options 222 through 232 that are related to the presentation of supplemental media assets. For example, in some embodiments, display 200 may be reachable by navigating another menu (e.g., accessible by selecting selectable option 222). In display 200, selectable option 224 is currently selected. In response, the media guidance application has presented supplemental media assets 206, 208, 210, and 212. For example, in response to a user selection, one or more of supplemental media assets 206, 208, 210, and 212 may be presented on a user device.

Display 200 also includes selectable option 226, which may be used to identify users and/or user devices that may receive supplemental media assets. In some embodiments, user devices that are determined to be associated with an identified user may receive supplemental media assets. For example, the media guidance application may link a plurality of user devices so that only users associated with the linked user devices may receive the supplemental media assets. In some embodiments, the media guidance application may receive user inputs (e.g., via selectable option 226) identifying each user (and/or user device) that should be able to receive the supplemental media assets. In some embodiments, the media guidance application may automatically identify the users based on various criteria. For example, the media guidance application may include settings that automatically share supplemental media assets in response to determining a geographic, demographic, familial, or social network relationship with users (e.g., a user viewing content on a first device and a user associated with a second device that enters a predetermined proximity to the first device while a media asset is presented on the first device) or user devices.

Display 200 also includes selectable option 228, which may be used by a user to select a predetermined proximity for sending/receiving supplemental media assets. For example, using selectable option 228, the media guidance application may select the size or the means used to determine the viewing area and/or predetermined proximity for sending/receiving supplemental media assets. Display 200 also includes selectable option 212. Selectable option 232 indicates the type, frequency, and/or any other characteristic of notification (e.g., related to available supplemental media assets) that is sent or received.

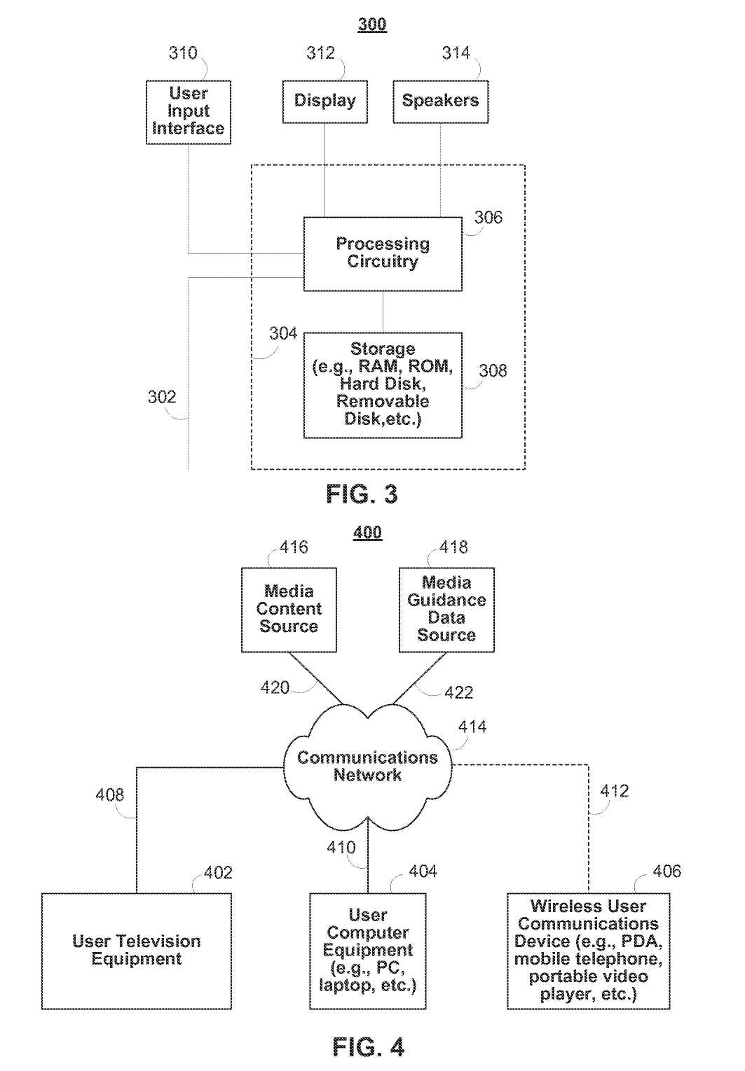

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data and guidance application data that are described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with, or combined with, display 312. Display 312 may be one or more of a monitor, a television, a liquid crystal display (LCD) for a mobile device, amorphous silicon display, low temperature polysilicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

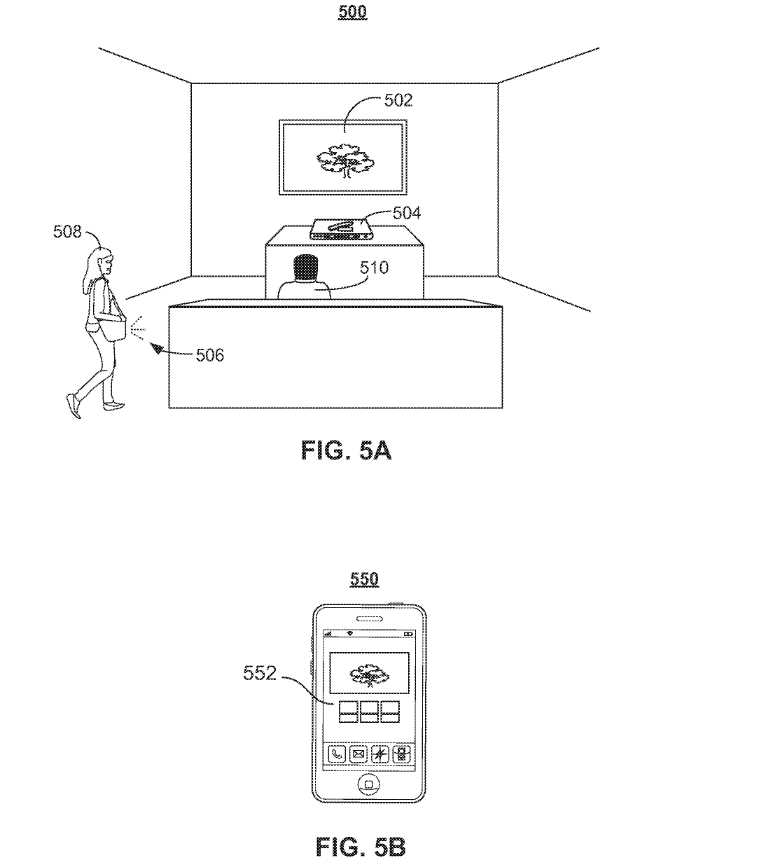

FIG. 5A is an example of a first device entering a predetermined proximity to a second device while the second is presenting a media asset. For example, FIG. 5A shows viewing area 500 associated with user device 504. In some embodiments, user device 504 may correspond to user equipment device 402 (FIG. 4). User device 504 is currently generating for display media asset 502 for consumption by a user (e.g., user 510).

Furthermore, in response to detecting that another user device (e.g., a smartphone carried in the purse of user 508), the media guidance application has notified (e.g., via the smartphone) user 508 of the availability of supplemental media assets related to media asset 502. For example, as indicated by audio alert 506, user 508 is being notified as user 508 enters the viewing area (e.g., correspond to a predetermined proximity from user device 504).

FIG. 5B is an example of a user device generating a prompt related to supplemental media assets. For example, FIG. 5B shows user device 550. User device may correspond to wireless user communications device 406 (FIG. 4). As shown in FIG. 5B, user device 550, which may have generated audio alert 506 (FIG. 5A), is currently showing several options related to supplemental media assets.

For example, user device 550 is currently displaying display 552. In some embodiments, display 552 may correspond to display 200 (FIG. 2). For example, display 552 may present options related to a plurality of supplemental media assets (e.g., supplemental media assets 206, 208, 210, and 212 (FIG. 2)). The supplemental media asset may represent the various types of supplemental media assets that correspond to a current progress point of media asset 502 (FIG. 5A).

For example, a media guidance application (e.g., implemented on user device 504 (FIG. 5A) or user device 550)) may determine (e.g., via control circuitry 304 (FIG. 3)) that user device 550 has entered a location (e.g., viewing area 500 (FIG. 5A)) at which an already in progress media asset (e.g., media asset 502 (FIG. 5A)) is being presented on another user device (e.g., user device 504 (FIG. 5A)). In response to determining that the media asset (e.g., media asset 502 (FIG. 5A)) is already in progress on another user device (e.g., user device 502 (FIG. 5A)), the media guidance application may determine (e.g., via control circuitry 304 (FIG. 3)) the events that have thus transpired in the media asset, and may generate for display (e.g., via control circuitry 304 (FIG. 3)) a summary of the events (e.g., display 552) on user device 550. Consequently, a first user (e.g., user 508 (FIG. 5A)) does not need to distract a second user (e.g., user 510 (FIG. 5A)) from viewing a media asset (e.g., media asset 502 (FIG. 5A)) on user device (e.g., user device 504 (FIG. 5A)) by asking questions related to the progress of the media asset (e.g., media asset 502 (FIG. 5A)).

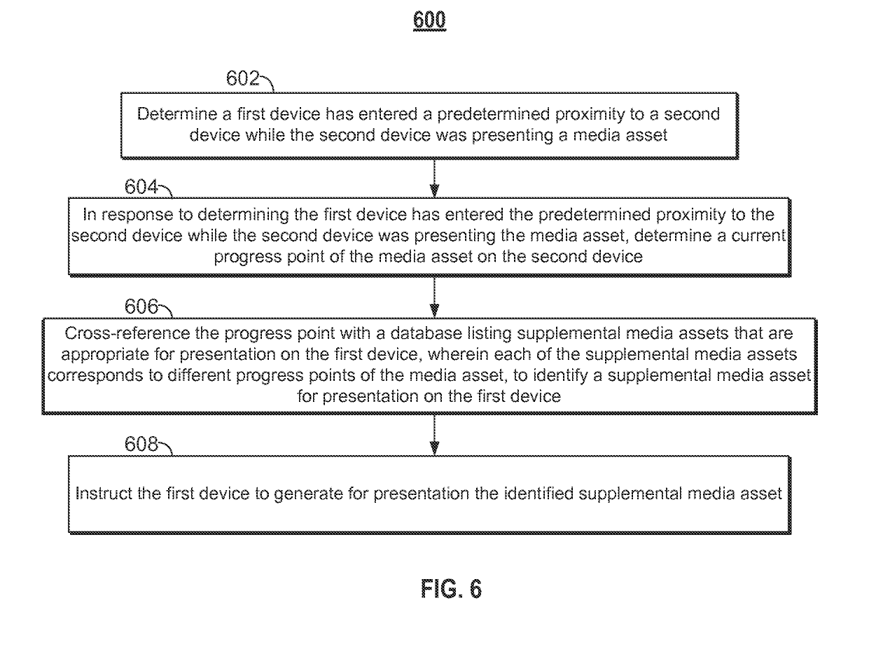

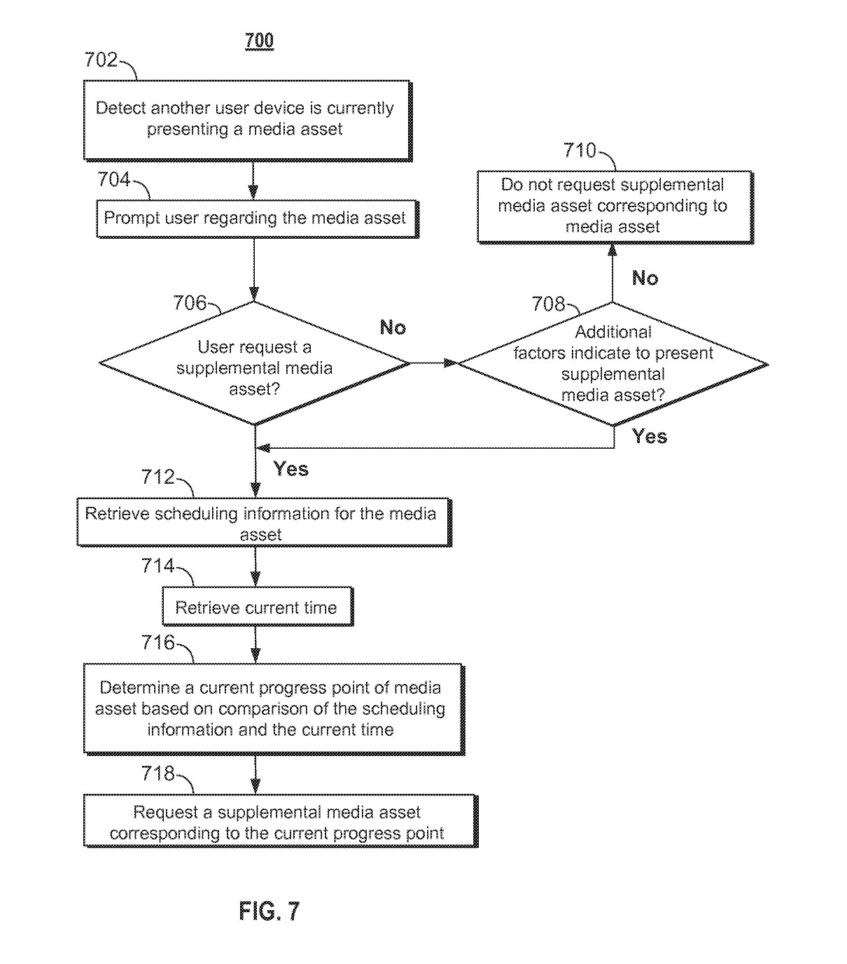

FIG. 6 is a flowchart of illustrative steps for instructing the first device to generate for presentation the identified supplemental media asset. It should be noted that process 600 or any step thereof could be performed on, or provided by, any of the devices shown in FIGS. 3-4. For example, process 600 may be executed by control circuitry 304 (FIG. 3) as instructed by a media guidance application implemented on a user device (e.g., user equipment devices 402, 404, and/or 406 (FIG. 4)) to generate or display supplemental media assets (e.g., as discussed in relation to FIGS. 5A-B)). In addition, one or more steps of process 600 may be incorporated into or combined with one or more steps of any other process or embodiment (e.g., process 700 (FIG. 7)).

At step 602, a media guidance application determines a first device has entered a predetermined proximity to a second device while the second device was presenting a media asset. For example, the media guidance application may determine (e.g., via control circuitry 304 (FIG. 3)) a first device (e.g., user device 550 (FIG. 5B)) has entered a predetermined proximity (e.g., viewing area 500 (FIG. 5A)) to a second device (e.g., user device 502 (FIG. 5A)) while the second device (e.g., user device 504 (FIG. 5A)) was presenting a media asset (e.g., media asset 502 (FIG. 5A)).

In some embodiments, to determine (e.g., via control circuitry 304 (FIG. 3)) whether or not the first user device (e.g., user device 550 (FIG. 5B)) is within the predetermined proximity (e.g., viewing area 500 (FIG. 5A)) to a second user device (e.g., user device 504 (FIG. 5A)), the media guidance application may base its determination on whether or not the first device can connect to a home network associated with the second device. In another example, to determine (e.g., via control circuitry 304 (FIG. 3)) whether or not a first user device is within a predetermined proximity to a second user device, the media guidance application may base its determination on data received from global positioning circuitry (e.g., incorporated into, accessible by, and/or coupled to control circuitry 304 (FIG. 3)). In yet another example, to determine whether or not a first user device (e.g., user device 550 (FIG. 5B)) is within a predetermined proximity to a second user device (e.g., user device 504 (FIG. 5A)), the media guidance application (e.g., via control circuitry 304 (FIG. 3)) may base its determination on whether or not a user input is received (e.g., via user input interface 310 (FIG. 3)) indicating that the first user device is within the predetermined proximity.

At step 604, the media guidance application determines a current progress point of the media asset on the second device in response to determining the first device has entered the predetermined proximity to the second device while the second device was presenting the media asset. In some embodiments, the media guidance application may determine (e.g., via control circuitry 304 (FIG. 3)) a current progress point of a media asset (e.g., media asset 502 (FIG. 5A)) based on status information received from the second device (e.g., user device 504 (FIG. 5A)). Alternatively or additionally, the media guidance application may determine (e.g., via control circuitry 304 (FIG. 3)) the current progress point of a media asset by comparing the current time to scheduling information associated with the media asset.

For example, the media guidance application may retrieve scheduling information associated with the media asset (e.g., from storage 308 (FIG. 3) and/or any location accessible via communications network 414 (FIG. 4)), determine a current time (e.g., via clock or counter circuitry incorporated into, accessible by, and/or coupled to control circuitry 304 FIG. 3)), and compare (e.g., via control circuitry 304 (FIG. 3)) the current time to the scheduling information to determine the current progress point of the media asset based on the scheduling information. For example, in response to determining (e.g., via control circuitry 304 (FIG. 3)) that a media asset is five minutes past its scheduled start time, the media guidance application may determine (e.g., via control circuitry 304 (FIG. 3)) that the current progress point of the media asset corresponds to the five minute mark in the media asset.

In another example, the media guidance application may determine (e.g., via control circuitry 304 (FIG. 3)) a progress point by identifying a video/audio signature associated with the current progress of the media asset (e.g., media asset 502 (FIG. 5A)). The media guidance application may then transmit (e.g., via control circuitry 304 (FIG. 3)) the video/audio signature to a remote server or database (e.g., media guidance data source 418 (FIG. 4)) and/or any location accessible via communications network 414 (FIG. 4)) listing video/audio signatures for each progress point in the media asset. The identified video/audio signature associated is then compared (e.g., via control circuitry 304 (FIG. 3)) to each of video/audio signatures for progress points of the media asset. In response to determining (e.g., via control circuitry 304 (FIG. 3)) the identified video/audio signature corresponds to one of the listed video/audio signatures, the media guidance application determines (e.g., via control circuitry 304 (FIG. 3)) the progress point associated with the listed video/audio signature as the current progress point.

At step 606, the media guidance application cross-references the progress point with a database listing supplemental media assets that are appropriate for presentation on the first device, in which each of the supplemental media assets corresponds to different progress points of the media asset, to identify a supplemental media asset for presentation on the first device. In some embodiments, the media guidance application may select (e.g., via control circuitry 304 (FIG. 3)) the supplemental media assets (e.g., supplemental media asset 206 (FIG. 2)) from a plurality of supplemental media assets based on the progress of the media asset on the second user device (e.g., user device 504 (FIG. 5A)). For example, the media guidance application may (e.g., via control circuitry 304 (FIG. 3)) input a current progress point into a database (e.g., located at storage 308 FIG. 3) or communications network 414 (FIG. 4)) listing supplemental content associated with different progress points in the media asset (e.g., media asset 502 (FIG. 5A)). The media guidance application may then filter (e.g., via control circuitry 304 (FIG. 3)) the supplemental media assets in the database based on whether or not the supplemental media asset corresponds to the current progress point. The database may then output to the media guidance application one or more supplemental media assets that correspond to the current progress point.

For example, a supplemental media asset (e.g., supplemental media asset 212 (FIG. 2)) may include a summary of the media asset (e.g., media asset 502 (FIG. 5A)), in which the summary summarizes the content of the media asset from a beginning point of the media asset only up to the current progress point (e.g., allowing a user to understand the events of the media asset, thus far). In another example, a supplemental media asset (e.g., supplemental media asset 206 (FIG. 2)) may include a portion of the media asset beginning at a beginning point of the media asset and ending at the current progress point (e.g., allowing a user to re-watch a portion of the media asset). In another example, a supplemental media asset (e.g., supplemental media asset 232 (FIG. 2)) may indicate an amount of time remaining in the media asset (e.g., allowing a user to determine whether to catch up on the current viewing of the media asset or instead view the media asset at a later time).

At step 608, the media guidance application instructs the first device to generate for presentation the identified supplemental media asset. For example, in response to determining (e.g., via control circuitry 304 (FIG. 3)) that another device (e.g., user device 504 FIG. 5A)) is already presenting a media asset (e.g., media asset 502 FIG. 5A)), the media guidance application may (e.g., via control circuitry 304 FIG. 3)) identify a supplemental media asset, from a plurality of supplemental media assets, for presentation to the user (e.g., user 508 (FIG. 5A)) on a first device (e.g., user device 550 (FIG. 5B)) based on the current progress point.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 6.

FIG. 7 is a flowchart of illustrative steps for determining whether or not to request a supplemental media asset. It should be noted that process 600 or any step thereof could be performed on, or provided by, any of the devices shown in FIGS. 3-4. For example, process 600 may be executed by control circuitry 304 (FIG. 3) as instructed by a media guidance application implemented on a user device (e.g., user equipment devices 402, 404, and/or 406 (FIG. 4)) in generate of display supplemental media assets (e.g., as discussed in relation to FIGS. 5A-B)). In addition, one or more steps of process 600 may be incorporated into or combined with one or more steps of any other process or embodiment (e.g., process 700 (FIG. 7)).

At step 702, the media guidance application detects another user device is currently presenting a media asset. For example, to determine that a media asset (e.g., media asset 502 (FIG. 5A)) is currently being presented on the second user device (e.g., user device 504 (FIG. 5A)), the media guidance application may receive (e.g., via I/O (path 302 (FIG. 3)) status information from the second user device. For example, the status information may indicate that the second user device is in an active state (e.g., the second user device is powered-on), may indicate the content currently presented on the second user device, may indicate the provider of the content, and/or any other media guidance data associated with the second user device, including, but not limited to a current progress point of the media asset on the second user device.

In some embodiments, the media guidance application may query (e.g., via control circuitry 304 (FIG. 3)) other devices within a predetermined proximity for status information periodically or in a continuous manner. Alternatively or additionally, the media guidance application may passively (e.g., without a request from the media guidance application) receive (e.g., via I/O path 302 (FIG. 3)) status information anytime a media asset is presented on a user device (e.g., user device 504 (FIG. 5A)).

At step 704, the media guidance application prompts a user regarding the media asset. For example, the media guidance application may alert (e.g., via audio alert 506 (FIG. 5A)) that supplemental media assets may be available for the currently presented media asset.

At step 706, the media guidance application determines whether or not a user requested a supplemental media asset. For example, the media guidance application may receive a user input (e.g., via user input interface 310 (FIG. 3)) requesting a supplemental media asset (e.g., supplemental media asset 206 (FIG. 2)). If the media guidance application determines (e.g., via control circuitry 304 (FIG. 3)) that a user input requesting the supplemental media asset is not received, the media guidance application proceeds to step 708. If the media guidance application determines (e.g., via control circuitry 304 (FIG. 3)) that a user input requesting the supplemental media asset was received, the media guidance application proceeds to step 712.

At step 708, the media guidance application determines whether or not additional factors indicate whether or not to present a supplemental media asset. For example, the media guidance application may determine (e.g., via control circuitry 304 (FIG. 3)) that the media asset is currently being recorded. If so, the media guidance application may (e.g., via control circuitry 304 (FIG. 3)) cancel the instruction to generate for presentation the supplemental media asset (e.g., supplemental media asset 206 (FIG. 2)) on a user device (e.g., user device 550 (FIG. 5B)). For example, the media guidance application may determine (e.g., via control circuitry 304 (FIG. 3)) that because the user has recorded the media asset, the user is likely to wish to re-watch the media asset in its entirety. Accordingly, the media guidance application may determine (e.g., via control circuitry 304 (FIG. 3)) not to generate for display supplemental media assets.

In another example, the media guidance application may determine (e.g., via control circuitry 304 (FIG. 3)) that because the current progress point is near the beginning of the media asset no supplemental media asset (e.g., supplemental media asset 206 (FIG. 2)) is necessary. Alternatively, the media guidance application may determine (e.g., via control circuitry 304 (FIG. 3)) that because the current progress point is near the end of the media asset (e.g., media asset 502 (FIG. 5A)) the user is unlikely to wish to attempt to catch up on the events of the media asset.

If the media guidance application determines (e.g., via control circuitry 304 (FIG. 3)) that additional factors do not indicate to present the supplemental media assets, the media guidance application proceeds to step 710 and does not request (e.g., from content source 416 and/or any location accessible via communications network 414 (FIG. 4)) a supplemental media asset corresponding to the media asset. If the media guidance application determines (e.g., via control circuitry 304 (FIG. 3)) that additional factors indicate to present the supplemental media assets, the media guidance application proceeds to step 712.

At step 712, the media guidance application retrieves scheduling information associated with the media asset (e.g., from storage 308 (FIG. 3) and/or any location accessible via communications network 414 (FIG. 4)). For example, the media guidance application may (e.g., via control circuitry 304 (FIG. 3)) input an identifier (e.g., a title, serial number, etc.) associated with the media asset (e.g., media asset 502 (FIG. 5A)) into a database (e.g., located at storage 308 FIG. 3) or communications network 414 (FIG. 4)) listing scheduling information from a plurality of the media assets. The media guidance application may then filter (e.g., via control circuitry 304 (FIG. 3)) the scheduling information in the database based on whether or not the scheduling information corresponds to the media asset. The database then output to the media guidance application the scheduling information corresponding to the media asset.

At step 714, the media guidance application determines a current time (e.g., via clock or counter circuitry incorporated into, accessible by, and/or coupled to control circuitry 304 FIG. 3)), and, at step 716, the media guidance application determines a current progress point of the media asset based on a comparison of the scheduling information and the current time. For example, the media guidance application compares (e.g., via control circuitry 304 (FIG. 3)) the current time to the scheduling information to determine the current progress point of the media asset based on the scheduling information. For example, in response to determining (e.g., via control circuitry 304 (FIG. 3)) that a media asset is five minutes past its scheduled start time, the media guidance application may determine (e.g., via control circuitry 304 (FIG. 3)) that the current progress point of the media asset corresponds to the five minute mark in the media asset.

At step 718, the media guidance application request a supplemental media asset corresponding to the current progress point. For example, as discussed in relation to step 606 (FIG. 6)), the media guidance application may (e.g., via control circuitry 304 (FIG. 3)) input a current progress point into a database (e.g., located at storage 308 FIG. 3) or communications network 414 (FIG. 4)) listing supplemental content associated with different progress points in the media asset (e.g., media asset 502 (FIG. 5A)). The media guidance application may then filter (e.g., via control circuitry 304 (FIG. 3)) the supplemental media assets in the database based on whether or not the supplemental media asset corresponds to the current progress point. The database may then output to the media guidance application one or more supplemental media assets that correspond to the current progress point.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel, or substantially simultaneously, to reduce lag or increase the speed of the system or method. Furthermore, it should be noted that any of the devices or equipment discussed in relation to FIGS. 3-4 could be used to perform one or more of the steps in FIG. 7.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for providing customized content, the method comprising:
determining a first device has entered a predetermined proximity to a second device while the second device was presenting a media asset;
in response to determining the first device has entered the predetermined proximity to the second device while the second device was presenting the media asset, determining a current progress point of the media asset on the second device;
cross-referencing the progress point with a database listing supplemental media assets that are appropriate for presentation on the first device, wherein each of the supplemental media assets corresponds to different progress points of the media asset, to identify a supplemental media asset for presentation on the first device; and
instructing the first device to generate for presentation the identified supplemental media asset.

2. The method of claim 1, wherein the identified supplemental media asset includes a summary of the media asset, wherein the summary summarizes the content of the media asset from a beginning point of the media asset only up to the current progress point.

3. The method of claim 1, wherein the identified supplemental media asset includes a portion of the media asset beginning at a beginning point of the media asset and ending at the current progress point.

4. The method of claim 1, wherein the identified supplemental media asset indicates an amount of time remaining in the media asset.

5. The method of claim 1, further comprising:
instructing the first device to generate for display a prompt indicating that the supplemental media asset is available; and
receiving a user input in response to the prompt requesting the supplemental media asset.

6. The method of claim 1, wherein the determination that the first device has entered the predetermined proximity to the second device is based on the first device connecting to a home network associated with the second device.

7. The method of claim 1, wherein the determination that the first device has entered the predetermined proximity to the second device is based on data received from a global positioning system.

8. The method of claim 1, wherein the first user device determines a length of time remaining in the media asset by:
retrieving scheduling information associated with the media asset;
determining a current time; and
comparing the current time to the schedule information to determine the length of time remaining in the media asset.

9. The method of claim 1, wherein the supplemental media assets that are appropriate for presentation on the first device are in a format corresponding to the first device.

10. The method of claim 1, further comprising:
determining whether the media asset is currently being recorded; and
in response to determining that the media asset is currently being recorded, canceling the instruction to generate for presentation the supplemental media asset on the first device.

11. A system for providing customized content, the system comprising:
storage circuitry configured to store a database listing supplemental media assets that are appropriate for presentation on a first device, wherein each of the supplemental media assets corresponds to different progress points of a media asset; and
control circuitry configured to:
determine the first device has entered a predetermined proximity to a second device while the second device was presenting the media asset;
in response to determining the first device has entered the predetermined proximity to the second device while the second device was presenting the media asset, determine a current progress point of the media asset on the second device;
cross-reference the progress point with the database to identify a supplemental media asset for presentation on the first device; and
instruct the first device to generate for presentation the identified supplemental media asset.

12. The system of claim 11, wherein the identified supplemental media asset includes a summary of the media asset, wherein the summary summarizes the content of the media asset from a beginning point of the media asset only up to the current progress point.

13. The system of claim 11, wherein the identified supplemental media asset includes a portion of the media asset beginning at a beginning point of the media asset and ending at the current progress point.

14. The system of claim 11, wherein the identified supplemental media asset indicates an amount of time remaining in the media asset.

15. The system of claim 11, wherein the control circuitry is further configured to:
instruct the first device to generate for display a prompt indicating that the supplemental media asset is available; and
receive a user input in response to the prompt requesting the supplemental media asset.

16. The system of claim 11, wherein the determination that the first device has entered the predetermined proximity to the second device is based on the first device connecting to a home network associated with the second device.

17. The system of claim 11, wherein the determination that the first device has entered the predetermined proximity to the second device is based on data received from a global positioning system.

18. The system of claim 11, wherein the control circuitry determines a length of time remaining in the media asset by:
retrieving scheduling information associated with the media asset;
determining a current time; and
comparing the current time to the schedule information to determine the length of time remaining in the media asset.

19. The system of claim 11, wherein the supplemental media assets that are appropriate for presentation on the first device are in a format corresponding to the first device.

20. The system of claim 11, wherein the control circuitry is further configured to:
determine whether the media asset is currently being recorded; and
in response to determining that the media asset is currently being recorded, cancel the instruction to generate for presentation the supplemental media asset on the first device.

21-50. (canceled)
